(19) United States
(12) Patent Application Publication
(10) Pub. No.: US 2025/0177889 A1
(43) Pub. Date: Jun. 5, 2025

(54) SLURRY FILTERING APPARATUS AND SEPARATOR MANUFACTURING SYSTEM INCLUDING SAME

(71) Applicant: LG ENERGY SOLUTION, LTD., Seoul (KR)

(72) Inventors: Ki-Deok KIM, Daejeon (KR); Ga-Yeon KIM, Daejeon (KR); Je-An LEE, Daejeon (KR)

(21) Appl. No.: 18/843,218

(22) PCT Filed: Jul. 4, 2023
(86) PCT No.: PCT/KR2023/009427

§ 371 Date: Sep. 2, 2024

(30) Foreign Application Priority Data
Dec. 23, 2022 (KR) 10-2022-0182926
Feb. 28, 2023 (KR) 10-2023-0027312

(51) Int. Cl. B01D 33/03; H01M 50/403

(52) U.S. Cl. CPC B01D 33/0315; B01D 2201/301; H01M 50/403

(57) ABSTRACT

Disclosed are a slurry filtering apparatus and a separator manufacturing system including the same. A slurry filtering apparatus according to one aspect of the present disclosure may include: an accommodation structure having an accommodation space therein, and a first inlet and a first outlet leading to the accommodation space; a filter accommodated in the accommodation space and configured to filter slurry flowing in through the first inlet and discharge the filtered slurry to the first outlet; and an ultrasonic module having at least a portion that is disposed in an internal space of the filter and configured to generate ultrasonic vibration inside the filter.

### CROSS-REFERENCE TO RELATED APPLICATION(S)

This application is a National Phase entry pursuant to 35 U.S.C. § 371 of International Application No. PCT/KR2023/009427, filed on Jul. 4, 2023, and claims the benefit of and priority to Korean Patent Application No. 10-2023-0027312, filed on Feb. 28, 2023, and Korean Patent Application No. 10-2022-0182926, filed on Dec. 23, 2022, with the Korean Intellectual Property Office, the disclosures of which are incorporated herein by reference in their entirety as if fully set forth herein.

### TECHNICAL FIELD

The present disclosure relates to a slurry filtering apparatus and a separator manufacturing system including the same, and more specifically, to a slurry filtering apparatus that filters slurry containing a coating material using ultrasonic waves and a separator manufacturing system for secondary batteries including the same.

### BACKGROUND

In general, secondary batteries refer to batteries capable of being repeatedly charged and discharged, such as lithium-ion batteries, lithium polymer batteries, nickel-cadmium batteries, nickel-hydrogen batteries, nickel-zinc batteries, and the like. These secondary batteries may be manufactured by storing an electrode assembly, including a positive electrode and a negative electrode laminated with an insulating separator interposed therebetween, and electrolyte materials in various types of cases and sealing the cases.

The separator of the secondary battery may be manufactured through a process of coating a porous polymer substrate with a slurry containing inorganic particles and binder polymer and then drying it. However, if the slurry for separator coating contains particles or foreign substances larger than the thickness of the separator or the thickness of the separator coating layer, there is a risk in which the separator may be physically damaged or may lose insulation during assembly of the secondary battery, resulting in a short circuit between electrodes. To prevent this risk, if the thickness of the separator is increased, the electrical capacity and energy density of the secondary battery will be lowered.

Accordingly, an existing technology uses a filter to remove large particles or foreign substances contained in the slurry, but in this existing technology, the filter is easily occluded due to the binder polymer contained in the slurry and the filter replacement cycle is short, thereby delaying the coating process or manufacturing process using slurry and increasing costs.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Problem

The present disclosure has been designed to solve the problems of the related art, and therefore the present disclosure is directed to providing a slurry filtering apparatus capable of increasing the continuous use time of a slurry filter and the amount of filtering per unit time and reducing the time and cost of the coating process or manufacturing process using slurry, and a separator manufacturing system including such a slurry filtering apparatus.

In addition, the present disclosure is directed to providing a slurry filtering apparatus that facilitates the management and replacement of a slurry filter, and a separator manufacturing system including such a slurry filtering apparatus.

In addition, the present disclosure is directed to providing a slurry filtering apparatus that ensures the durability and insulation of a separator for secondary batteries and enables thinning of the separator, thereby improving the electrical capacity and energy density of secondary batteries, and a separator manufacturing system including such a slurry filtering apparatus.

### Technical Solution

A slurry filtering apparatus according to one aspect of the present disclosure may include: an accommodation structure having an accommodation space therein, and a first inlet and a first outlet leading to the accommodation space; a filter accommodated in the accommodation space and configured to filter slurry flowing in through the first inlet and discharge the filtered slurry to the first outlet; and an ultrasonic module having at least a portion that is disposed in an internal space of the filter and configured to generate ultrasonic vibration inside the filter.

In an embodiment, the accommodation structure may include: a base structure having the first inlet and the first outlet, and supporting the filter; and a cap structure capable of being coupled to and separated from the base structure and forming the accommodation space by being coupled to the base structure.

In an embodiment, the base structure may include: a first insertion groove into which at least one end of the filter is inserted so as to be seated thereon; a second insertion groove provided on an inner surface of the first insertion groove so as to lead to the first inlet and into which a second inlet provided at the at least one end of the filter is inserted; and a third insertion groove provided on the inner surface of the first insertion groove so as to lead to the first outlet and into which a second outlet provided at the at least one end of the filter is inserted.

In an embodiment, the filter may include a porous structure configured to filter the slurry flowing in through the first inlet, and the at least a portion of the ultrasonic module may be disposed in a hollow provided inside the porous structure.

In an embodiment, the porous structure may include a plurality of porous layers stacked on each other from the hollow toward outside of the porous structure.

In an embodiment, pores formed in the plurality of porous layers may have a smaller size as they are located closer to the hollow.

In an embodiment, the filter may further include a filter housing accommodating the porous structure therein, and the filter housing may include: a second inlet leading to the first inlet and configured to provide the slurry flowing in through the first inlet to the porous structure; and a second outlet leading to the first outlet and configured to discharge the slurry filtered through the porous structure to the first outlet.

In an embodiment, the porous structure may have an opening leading to the hollow, and the opening may be configured to lead to the second outlet.

In an embodiment, the ultrasonic module may include: an insertion rod having a predetermined length and having at least one end inserted into the internal space of the filter; and at least one vibrator coupled to and supported by the at least one end of the insertion rod and configured to generate ultrasonic vibration.

In an embodiment, the ultrasonic module may include a plurality of vibrators, and the plurality of vibrators may be coupled to the at least one end of the insertion rod so as to be spaced a predetermined distance apart from each other in the longitudinal direction of the insertion rod.

In an embodiment, the ultrasonic module may further include an oscillator configured to generate a high-frequency electrical signal corresponding to an oscillation frequency of the at least one vibrator and to provide the same to the at least one vibrator.

In an embodiment, the insertion rod may be inserted into the internal space of the filter through the first outlet.

A separator manufacturing system according to another aspect of the present disclosure includes the slurry filtering apparatus according to any one of the embodiments described above.

### Advantageous Effects

According to the present disclosure, since at least a portion of an ultrasonic module is disposed in the internal space of the filter to generate ultrasonic vibration from the inside of the filter toward the outside thereof, it is possible to effectively prevent occlusion of the innermost porous portions of the filter where aggregation of particles contained in the slurry occurs most frequently. As a result, it is possible to increase the continuous use time of the filter and the amount of filtering per unit time and reduce the time and cost of the coating process or manufacturing process using slurry.

In addition, since a base structure and a cap structure of an accommodation structure, which form a filter accommodation space by mutual coupling, are configured to be separated from each other, it is easy to manage or replace the filter.

In addition, since a porous structure of the filter, which filters the slurry, includes a plurality of porous layers stacked on each other from the hollow provided inside the porous structure toward the outside of the porous structure, it is possible to improve the performance of filtering particles contained in the slurry.

In addition, since the pores formed in the respective porous layers are configured to have a smaller diameter as they are located closer to the hollow, it is possible to prevent occlusion of the pores by the particles contained in the slurry and increase the effect of dispersing particles by ultrasonic vibration.

In addition, since vibrators of the ultrasonic module are disposed in the internal space of the filter so as to be spaced apart from each other in one direction and configured to generate ultrasonic vibration, it is possible to increase the transmission area of ultrasonic vibration transmitted to the filter and further improve the filtering performance.

In addition, by applying the slurry filtering apparatus according to the present disclosure to a separator manufacturing system, it is possible to reduce the time and cost of the separator coating process or manufacturing process, ensure the durability and insulation of the separator, and enable thinning of the separator, thereby improving the electrical capacity and energy density of secondary batteries.

Furthermore, those skilled in the art to which the present disclosure pertains will be able to clearly understand from the following description that various embodiments according to the present disclosure are able to solve various technical problems not mentioned above.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus the present disclosure is not construed as being limited to the drawing.

FIG. 1 is a perspective view illustrating a slurry filtering apparatus according to an embodiment of the present disclosure.

FIG. 2 is an exploded perspective view illustrating the slurry filtering apparatus shown in FIG. 1.

FIG. 3 is a diagram illustrating the internal structure of a filter included in a slurry filtering apparatus according to an embodiment of the present disclosure.

FIG. 4 is a diagram illustrating an example of a porous structure manufacturing method applicable to the filter shown in FIG. 3.

FIG. 5 is a cross-sectional view taken along line S1-S1′ of the slurry filtering apparatus shown in FIG. 1.

FIG. 6 is a diagram illustrating a separator manufacturing system according to an embodiment of the present disclosure.

### DETAILED DESCRIPTION

Hereinafter, embodiments according to the present disclosure will be described in detail with reference to the accompanying drawings to clarify solutions corresponding to the technical problems of the present disclosure. However, in describing the present disclosure, a description of related known technology, which may obscure the subject matter of the present disclosure, may be omitted. In addition, the terms used in this specification are defined in consideration of the functions in the present disclosure and may vary depending on the intention of the designer, manufacturer, etc. or custom thereof. Therefore, definitions of the terms described below should be made based on the description throughout this specification.

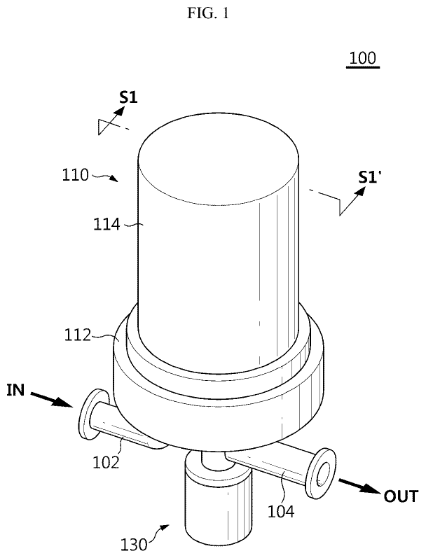

FIG. 1 is a perspective view illustrating a slurry filtering apparatus 100 according to an embodiment of the present disclosure.

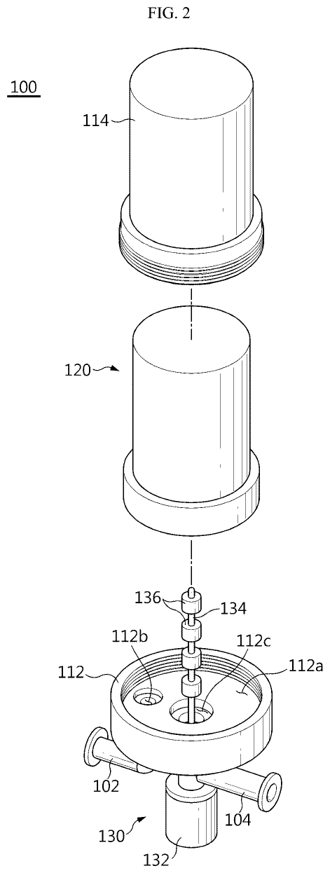

FIG. 2 is an exploded perspective view illustrating the slurry filtering apparatus 100 shown in FIG. 1.

As shown in FIGS. 1 and 2, a slurry filtering apparatus 100 according to an embodiment of the present disclosure includes an accommodation structure 110, a filter 120, and an ultrasonic module 130.

The accommodation structure 110 has an accommodation space therein and includes a first inlet 102 and a first outlet 104 that lead to the accommodation space. A filter 120 for filtering slurry is accommodated in the accommodation space provided inside the accommodation structure 110. The slurry supplied from a predetermined slurry supply device (not shown) and flowing in through the first inlet 102 may be provided to the filter 120 accommodated in the accommodation space, and the slurry filtered by the filter 120 may be discharged through the outlet 104.

In an embodiment, the accommodation structure 110 may include a base structure 112 and a cap structure 114.

In this case, the base structure 112 of the accommodation structure 110 may have the first inlet 102 and the first outlet 104 and may be configured to support the filter 120. To this end, the base structure 112 may include a first insertion groove 112a, a second insertion groove 112b, and a third insertion groove 112c.

The first insertion groove 112a may be configured such that at least one end of the filter 120 is inserted into and seated on the same.

The second insertion groove 112b may be provided on the inner surface of the first insertion groove 112a to lead to the first inlet 102, and may be configured such that a second inlet provided at the one end of the filter 120 is inserted thereto.

The third insertion groove 112c may be provided on the inner surface of the first insertion groove 112a to lead to the first outlet 104, and may be configured such that a second outlet provided at the one end of the filter 120 is inserted thereto.

For example, the lower end of the filter 120 may be inserted into and seated on the first insertion groove 112a. In addition, the lower end of the filter 120 may have a second inlet and a second outlet configured in a tube structure and protruding therefrom. The second inlet of the filter 120 may be inserted into the second insertion groove 112b so as to lead to the first inlet 102 of the accommodation structure 110, and the second outlet of the filter 120 may be inserted into the third insertion groove 112c so as to lead to the first outlet 104 of the accommodation structure 110.

The cap structure 114 of the accommodation structure 110 may be coupled to and separated from the base structure 112 described above, and may be configured to form an accommodation space for accommodating the filter 120 by coupling with the base structure 112.

For example, the base structure 112 and the cap structure 114 of the accommodation structure 110 may be configured to be coupled by a screw engagement method. To this end, a thread may be formed on the inner surface of the first insertion groove 112a of the base structure 112, and a corresponding thread may be formed on the outer circumferential surface of the lower end of the cap structure 114.

As described above, since the base structure 112 and the cap structure 114 of the accommodation structure 110, which form the filter accommodation space by mutual coupling, are configured to be separated from each other, it is easy to manage or replace the filter.

As will be explained again below, the filter 120 is accommodated in the accommodation space provided inside the accommodation structure 110 and is configured to filter the slurry flowing in through the first inlet 102 and discharge the filtered slurry to the first outlet 104.

At least a portion of the ultrasonic module 130 is disposed in the internal space of the filter 120 and is configured to generate ultrasonic vibration from the inside of the filter 120 to the outside thereof. To this end, the ultrasonic module 130 may include an oscillator 132, an insertion rod 134, and a vibrator 136.

The oscillator 132 may be configured to generate a high-frequency electrical signal corresponding to the oscillation frequency of the vibrator 136 and provide the same to the vibrator 136. The frequency of the high-frequency electrical signal generated by the oscillator 132 may range from 30 to 10,000 [kHz].

The insertion rod 134 may have a specific length and may be configured such that at least one end thereof is inserted into the internal space of the filter 120. This insertion rod 134 may serve as a support structure for supporting the vibrator 136. Depending on the embodiment, the insertion rod 134 may also be configured to serve as a connection member that electrically connects the oscillator 132 and the vibrator 136.

This insertion rod 134 may be configured to be inserted into the internal space of the filter 120 through the first outlet 104 of the accommodation structure 110. That is, the insertion rod 134 may be inserted into the internal space of the filter 120 through the first outlet 104 of the accommodation structure 110, the third insertion groove 112c of the accommodation structure 110 leading to the first outlet 104, and the second outlet of the filter 120 inserted into the third insertion groove 112c.

The vibrator 136 may be coupled to and supported by one end of the insertion rod 134 located in the internal space of the filter 120, and may be configured to generate ultrasonic vibration according to a high-frequency electrical signal provided from the oscillator 132. To this end, the vibrator 136 may include a piezo-electric vibrator or a magnetostrictive vibrator.

In an embodiment, the ultrasonic module 130 may include a plurality of vibrators 136. In this case, the plurality of vibrators 136 may be coupled to one end of the insertion rod 134 located in the internal space of the filter 120 so as to be spaced a predetermined distance apart from each other in the longitudinal direction of the insertion rod 134. For example, the plurality of vibrators 136 may be coupled to the insertion rod 134 so as to be spaced apart from each other by a predetermined distance ranging from 10 to 50 [mm].

As described above, since at least a portion of the ultrasonic module 130 is disposed in the internal space of the filter 120 to generate ultrasonic vibration from the inside of the filter 120 to the outside thereof, it is possible to effectively prevent occlusion of the innermost porous parts of the filter where aggregation of particles contained in the slurry occurs most frequently. As a result, it is possible to increase the continuous use time of the filter and the amount of filtering per unit time and reduce the time and cost of the coating process or manufacturing process using slurry.

In addition, since vibrators of the ultrasonic module 130 are disposed in the internal space of the filter 120 so as to be spaced a predetermined distance apart from each other in one direction and configured to generate ultrasonic vibration, it is possible to increase the transmission area of ultrasonic vibration transmitted to the filter and further improve the filtering performance.

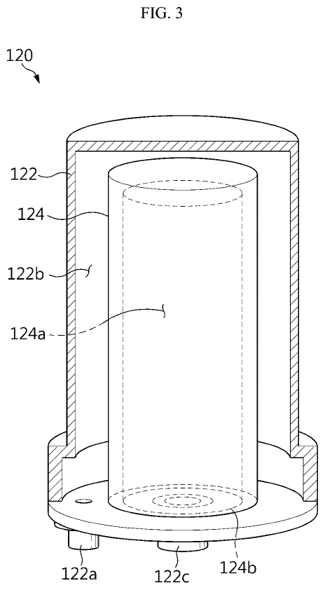

FIG. 3 is a diagram illustrating the internal structure of a filter 120 included in a slurry filtering apparatus according to an embodiment of the present disclosure.

As shown in FIG. 3, the filter 120 may include a filter housing 122 and a porous structure 124.

The filter housing 122 may be configured to accommodate the porous structure 124 therein. This filter housing 122 may include a second inlet 122a, an accommodation space 122b, and a second outlet 122c.

The second inlet 122a may be configured to lead to the first inlet 102 of the above-described accommodation structure 110 and provide the slurry flowing in through the first inlet 102 to the porous structure 124 accommodated in the accommodation structure 110. As mentioned above, the second inlet 122a may be configured in a tube structure and may protrude outside the filter 120 so as to be inserted into the second insertion groove 112b provided in the base structure 112 of the accommodation structure 110.

The accommodation space 122b may be configured to accommodate the slurry flowing in through the porous structure 124 and the second inlet 122a.

The second outlet 122c may be configured to lead to the first outlet 104 of the accommodation structure 110 and discharge the slurry filtered through the porous structure 124 to the first outlet 104. As mentioned above, the second outlet 122c may have a tubular structure and protrude outside the filter 120 so as to be inserted into the third insertion groove 112c provided in the base structure 112 of the accommodation structure 110.

The porous structure 124 may be configured to have multiple pores and filter slurry flowing in through the first inlet 102 of the accommodation structure 110 and the second inlet 122a of the filter housing 122.

To this end, the porous structure 124 may have a hollow 124a formed therein and an opening 124b leading to the hollow 124a. a. The opening 124b of the porous structure 124 may be configured to lead to the second outlet 122c of the filter housing 122.

That is, the slurry contained in the accommodation space 122b of the filter housing 122 is filtered by passing through the porous structure 124, and the filtered slurry is collected in the hollow 124a of the porous structure 124. The slurry collected in the hollow of the porous structure 124 may be discharged to the first outlet 104 of the accommodation structure 110 through the opening 124b of the porous structure 124 and the second outlet 122c of the filter housing 122.

In this case, a portion of the ultrasonic module 130 may be disposed in the hollow 124a provided inside the porous structure 124. That is, the insertion rod 134 and the vibrator 136 of the ultrasonic module 130 may be disposed in the hollow 124a of the porous structure 124.

In an embodiment, the porous structure 124 may include a plurality of porous layers stacked on each other from the hollow 124a toward the outside of the porous structure 124. In this case, the pores formed in the plurality of porous layers may be configured to have a smaller size as they are located closer to the hollow 124a.

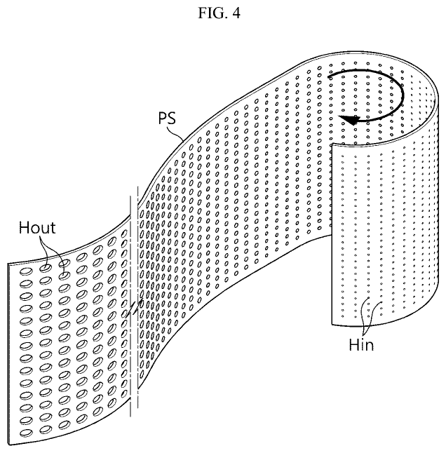

FIG. 4 is a diagram illustrating an example of a porous structure manufacturing method applicable to the filter 120 shown in FIG. 3.

As shown in FIG. 4, the porous structure 124 may be manufactured by winding a porous substrate PS in the form of a sheet or film in one direction. As a result, the porous structure 124 may include a plurality of porous layers stacked on each other from the hollow 124a toward the outside of the porous structure 124.

In this case, the pores Hᵢₙ and Hₒᵤₜ formed in the plurality of porous layers may be configured to have a smaller size as they are located closer to the hollow 124a. To this end, the sizes of the pores Hᵢₙ and Hₒᵤₜ formed in the porous substrate PS may be configured to be gradually reduced as they are located from one end of the porous substrate PS, which corresponds to the outer portion thereof after winding, to the other end of the porous substrate PS, which corresponds to the inner portion thereof after winding. That is, the size of the pore Hᵢₙ formed on the other end of the porous substrate PS may be less than the size of the pore Hₒᵤₜ formed on one end of the porous substrate PS.

As described above, since the porous structure 124 of the filter 120 includes a plurality of porous layers stacked on each other from the hollow 124a provided therein toward the outside of the porous structure 124, it is possible to improve the performance of filtering particles contained in the slurry.

In addition, since the pores formed in the respective porous layers are configured to have a smaller diameter as they are located closer to the hollow 124a, it is possible to prevent occlusion of the pores by the particles contained in the slurry and increase the effect of dispersing particles by ultrasonic vibration.

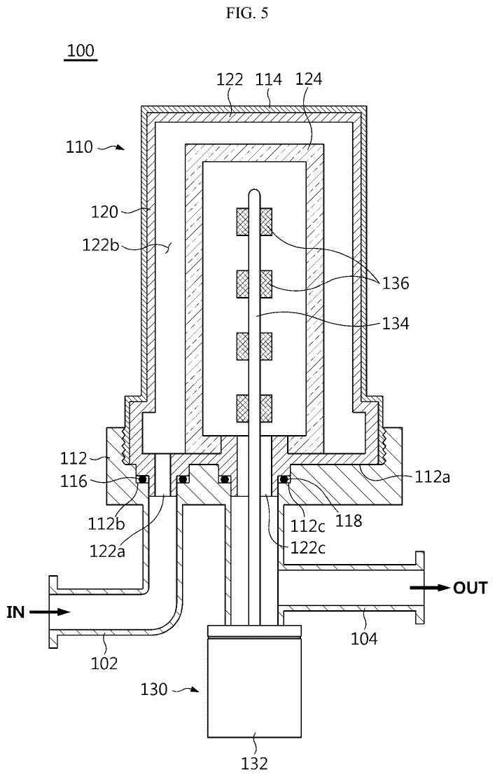

FIG. 5 is a cross-sectional view taken along line S1-S1′ of the slurry filtering apparatus 100 shown in FIG. 1.

As shown in FIG. 5, the accommodation structure 110 of the slurry filtering apparatus 100 may include a base structure 112 and a cap structure 114.

The base structure 112 may have a first inlet 102 and a first outlet 104, and may support the filter 120. In this case, the lower end of the filter 120 may be inserted into and seated on the first insertion groove 112a of the base structure 112.

In addition, the second inlet 122a of the filter 120 may be inserted into the second insertion groove 112b of the base structure 112 so as to lead to the first inlet 102 of the accommodation structure 110. In this case, an O-ring 116 that prevents slurry from leaking may be interposed between the second inlet 122a of the filter 120 and the second insertion groove 112b of the base structure 112.

In addition, the second outlet 122c of the filter 120 may be inserted into the third insertion groove 112c of the accommodation structure 110 so as to lead to the first outlet 104 of the accommodation structure 110. In this case, an O-ring 118 that prevents slurry from leaking may be interposed between the second outlet 122c of the filter 120 and the third insertion groove 112c of the base structure 112.

The cap structure 114 may be coupled to the base structure 112 to form an accommodation space for accommodating the filter 120.

Next, the slurry supplied from a predetermined slurry supply device (not shown) and flowing in through the first inlet 102 may be received in the accommodation space 122b of the filter housing 122 through the second inlet 122a of the filter 120.

The slurry received in the accommodation space 122b of the filter housing 122 is filtered while passing through the porous structure 124 of the filter 120 and then collected in the hollow 124a of the porous structure 124.

The filtered slurry collected in the hollow 124a of the porous structure 124 may be discharged to the outside through the second outlet 122c of the filter housing 122 and the first outlet 104 of the base structure 112.

While performing filtering as described above, the ultrasonic module 130 of the slurry filtering apparatus 100 may generate ultrasonic vibration from the inside of the filter 120 to the outside thereof, thereby preventing occlusion of the porous structure 124.

To this end, one end of the insertion rod 134 of the ultrasonic module 130 and a plurality of vibrators 136 may be disposed in the hollow 124a of the porous structure 124. In this case, the insertion rod 134 may be inserted into the hollow 124a of the porous structure 124 through the first outlet 104 of the accommodation structure 110 and the second outlet 122c of the filter 120.

The plurality of vibrators 136 may be coupled to one end of the insertion rod 134 located in the internal space of the filter 120 so as to be spaced a predetermined distance apart from each other in the longitudinal direction of the insertion rod 134. For example, the plurality of vibrators 136 may be coupled to the insertion rod 134 so as to be spaced apart from each other by a predetermined distance ranging from 10 to 50 [mm].

When the high-frequency electrical signal generated by the oscillator 132 of the ultrasonic module 130 is transmitted to the plurality of vibrators 136, each of the plurality of vibrators 136 may generate ultrasonic vibration according to the high-frequency electrical signal. In this case, the frequency of the high-frequency electrical signal generated by the oscillator 132 may range from 30 to 10,000 [KHz].

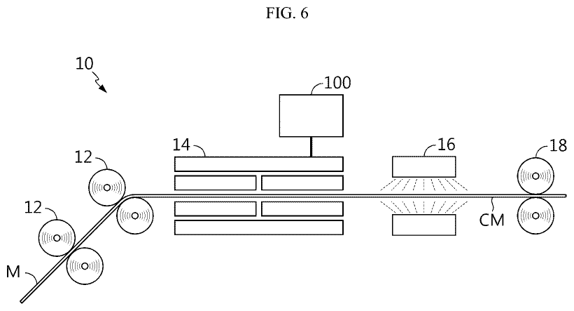

FIG. 6 is a diagram illustrating a separator manufacturing system 10 according to an embodiment of the present disclosure.

As shown in FIG. 6, a separator manufacturing system 10 according to an embodiment of the present disclosure may include a substrate supply unit 12 that supplies a porous polymer substrate M, a coating unit 14 that applies coating slurry filtered by the slurry filtering apparatus 100 according to the present disclosure to the porous polymer substrate M, a drying unit 16 that dries the solvent contained in the coating slurry, and a winding unit 18 that winds the porous polymer substrate CM on which a coating layer is formed in a roll shape.

The porous polymer substrate M is a substrate in which multiple pores are formed. These pores are configured to lead to each other, allowing gas or liquid to pass from one side of the substrate to the other side thereof. As such a porous polymer substrate, a porous polymer film containing a thermoplastic resin may be used from the viewpoint of providing a shutdown function. The shutdown function refers to a function of preventing thermal runaway of the battery, when the battery temperature rises high, by blocking movement of ions by melting the thermoplastic resin and occluding the pores of the porous substrate. The thermoplastic resin may have a melting point of approximately 200° C. or less in terms of the shutdown function.

The thickness of the porous polymer substrate is not specifically limited, but may be approximately in the range of 1 μm to 100 μm or in the range of 5 μm to 50 μm, and the pores provided in the porous polymer substrate are also not specifically limited, but may be approximately in the range of 10% to 95% or in the range of 35% to 65%.

In the porous coating layer coated on the porous polymer substrate, inorganic particles may come into contact with each other to be bound to each other by binder polymer, thereby forming interstitial volumes between the inorganic particles, and the interstitial volumes may make a porous structure in the coating layer.

In an embodiment, the weight ratio of the inorganic particles to the binder polymer in the porous coating layer may be 99:1 to 50:50.

In the present disclosure, the binder polymer is not specifically limited as long as it is able to provide bonding force between the inorganic particles and bonding force between the porous coating layer and the electrode. For example, the binder polymer may include one or more selected from the group consisting of polyvinylidene fluoride-co-hexafluoro propylene (PVDF-co-HFP), polyvinylidene fluoride-co-trichloro ethylene, polyvinylidene fluoride-co-chlorotrifluoro ethylene, poly (methyl)methacrylate, poly ethyl (meth)acrylate, poly n-propyl (meth)acrylate, poly isopropyl (meth)acrylate, poly n-butyl (meth)acrylate, poly t-butyl (meth)acrylate, poly sec-butyl (meth)acrylate, poly pentyl (meth)acrylate, poly 2-ethylbutyl poly (meth)acrylate, poly 2-ethylhexyl (meth)acrylate, poly n-octyl (meth)acrylate, poly isooctyl (meth)acrylate, poly isononyl (meth)acrylate, poly lauryl (meth)acrylate, poly tetradecyl (meth)acrylate, poly N-vinylpyrrolidinone, polyacrylonitrile, polyvinylacetate, polyethylene-co-vinyl acetate, polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, acrylonitrile-styrene-butadiene copolymer, and polyimide.

In addition, the binder polymer may be a particle-type binder polymer resin. For example, it may be an acrylic copolymer, styrene butadiene rubber, or a mixture of two or more thereof, and the acrylic copolymer may include copolymer of ethylhexyl acrylate and methyl methacrylate, polymethylmethacrylate, polyethylhexyl acrylate, polybutylacrylate, polyacrylonitrile, copolymer of butylacrylate and methyl methacrylate or a mixture of two or more thereof.

In the present disclosure, the inorganic particles are not specifically limited as long as they are electrochemically stable. For example, the inorganic particles are not specifically limited as long as oxidation and/or reduction reactions do not occur in the operating voltage range of the applied electrochemical device (e.g., 0 to 5 V based on Li/Li+), and may include, as unlimited examples, ZrO₂, BaTiO₃, Pb(Zr,Ti)O₃(PZT), Pb₁₋ₓLaₓZr_{1-y}Ti_{y}O₃(PLZT), PB(Mg₃Nb_{2/3})O₃—PbTiO₃(PMN-PT), Hafnia (HfO₂), SrTiO₃, SnO₂, CeO₂, MgO, NiO, CaO, ZnO, ZrO₂, Y₂O₃, Al₂O₃, TiO₂, AlOOH, Al(OH)₃, SiC, or mixtures thereof. Meanwhile, in addition thereto, inorganic particles of lithium phosphate (Li₃PO₄), lithium titanium phosphate (LiₓTi_{y}(PO₄)₃, 0<x<2 and 0<y<3), lithium aluminum titanium phosphate (LiₓAl_{y}Ti_{z}(PO₄)₃, 0<x<2, 0<y<1, and 0<z<3), (LiAlTiP)ₓO_{y}-based glass (0<x<4 and 0<y<13), lithium lanthanum titanate (LiₓLa_{y}TiO₃, 0<x<2 and 0<y<3), lithium germanium thiophosphate (LiₓGe_{y}P_{z}S_{w}, 0<x<4, 0<y<1, 0<z<1, and 0<w<5), lithium nitride (LiₓN_{y}, 0<x<4, and 0<y<2), SiS₂-based glass (LiₓSi_{y}S_{z}, 0<x<3, 0<y<2, and 0<z<4), P₂S₅-based glass (LiₓP_{y}S_{z}, 0<x<3, 0<y<3, and 0<z<7) or two or more thereof may be further included.

For reference, the slurry filtering apparatus 100 according to the present disclosure may also be applied to various coating processes using coating slurry as well as the above-described separator manufacturing system. That is, the slurry filtering apparatus 100 according to the present disclosure may also be applied to a coating process for a positive or negative electrode using slurry.

As described above, according to the present disclosure, since at least a portion of an ultrasonic module is disposed in the internal space of the filter to generate ultrasonic vibration from the inside of the filter toward the outside thereof, it is possible to effectively prevent occlusion of the innermost porous portions of the filter where aggregation of particles contained in the slurry occurs most frequently. As a result, it is possible to increase the continuous use time of the filter and the amount of filtering per unit time and reduce the time and cost of the coating process or manufacturing process using slurry.

In addition, since a base structure and a cap structure of an accommodation structure, which form a filter accommodation space by mutual coupling, are configured to be separated from each other, it is easy to manage or replace the filter.

In addition, since a porous structure of the filter, which filters the slurry, includes a plurality of porous layers stacked on each other from the hollow provided inside the porous structure toward the outside of the porous structure, it is possible to improve the performance of filtering particles contained in the slurry.

In addition, since the pores formed in the respective porous layers are configured to have a smaller diameter as they are located closer to the hollow, it is possible to prevent occlusion of the pores by the particles contained in the slurry and increase the effect of dispersing particles by ultrasonic vibration.

In addition, since vibrators of the ultrasonic module are disposed in the internal space of the filter so as to be spaced apart from each other in one direction and configured to generate ultrasonic vibration, it is possible to increase the transmission area of ultrasonic vibration transmitted to the filter and further improve the filtering performance.

In addition, by applying the slurry filtering apparatus according to the present disclosure to a separator manufacturing system, it is possible to reduce the time and cost of the separator coating process or manufacturing process, ensure the durability and insulation of the separator, and enable thinning of the separator, thereby improving the electrical capacity and energy density of secondary batteries.

Furthermore, it goes without saying that the embodiments according to the present disclosure are able to solve various technical problems other than those mentioned in this specification in the relevant technical fields as well as this technical field.

So far, the present disclosure has been described with reference to specific embodiments. However, those skilled in the art will clearly understand that various modified embodiments may be implemented within the technical scope of the present disclosure. Therefore, the previously disclosed embodiments should be considered as those intended to describe the present disclosure, instead of those intended to limit the present disclosure. In other words, the true scope of the technical idea of the present disclosure is shown in the claims, and all differences within the scope equivalent thereto should be construed as being included in the present disclosure.

1. A slurry filtering apparatus, comprising:
an accommodation structure having an accommodation space therein, and a first inlet and a first outlet leading to the accommodation space;
a filter accommodated in the accommodation space and configured to filter slurry flowing in through the first inlet and discharge the filtered slurry to the first outlet; and
an ultrasonic module having at least a portion that is disposed in an internal space of the filter and configured to generate ultrasonic vibration inside the filter.

2. The slurry filtering apparatus according to claim 1,
wherein the accommodation structure comprises:
a base structure having the first inlet and the first outlet, and supporting the filter; and
a cap structure capable of being coupled to and separated from the base structure and forming the accommodation space by being coupled to the base structure.

3. The slurry filtering apparatus according to claim 2,
wherein the base structure comprises:
a first insertion groove into which at least one end of the filter is inserted so as to be seated thereon;
a second insertion groove provided on an inner surface of the first insertion groove so as to lead to the first inlet and into which a second inlet provided at the at least one end of the filter is inserted; and
a third insertion groove provided on the inner surface of the first insertion groove so as to lead to the first outlet and into which a second outlet provided at the at least one end of the filter is inserted.

4. The slurry filtering apparatus according to claim 1,
wherein the filter comprises a porous structure configured to filter the slurry flowing in through the first inlet, and
wherein the at least a portion of the ultrasonic module is disposed in a hollow provided inside the porous structure.

5. The slurry filtering apparatus according to claim 4,
wherein the porous structure comprises a plurality of porous layers stacked on each other from the hollow toward outside of the porous structure.

6. The slurry filtering apparatus according to claim 5,
wherein pores formed in the plurality of porous layers have a smaller size as they are located closer to the hollow.

7. The slurry filtering apparatus according to claim 4,
wherein the filter further comprises a filter housing accommodating the porous structure therein, and
wherein the filter housing comprises:
a second inlet leading to the first inlet and configured to provide the slurry flowing in through the first inlet to the porous structure; and
a second outlet leading to the first outlet and configured to discharge the slurry filtered through the porous structure to the first outlet.

8. The slurry filtering apparatus according to claim 7,
wherein the porous structure has an opening leading to the hollow, and
wherein the opening is configured to lead to the second outlet.

9. The slurry filtering apparatus according to claim 1,
wherein the ultrasonic module comprises:
an insertion rod having a predetermined length and having at least one end inserted into the internal space of the filter; and
at least one vibrator coupled to and supported by the at least one end of the insertion rod and configured to generate ultrasonic vibration.

10. The slurry filtering apparatus according to claim 9,
wherein the ultrasonic module comprises a plurality of vibrators, and
wherein the plurality of vibrators are coupled to the at least one end of the insertion rod so as to be spaced a predetermined distance apart from each other in the longitudinal direction of the insertion rod.

11. The slurry filtering apparatus according to claim 9,
wherein the ultrasonic module further comprises:
an oscillator configured to generate a high-frequency electrical signal corresponding to an oscillation frequency of the at least one vibrator and to provide the same to the at least one vibrator.

12. The slurry filtering apparatus according to claim 9,
wherein the insertion rod is inserted into the internal space of the filter through the first outlet.

13. A separator manufacturing system comprising the slurry filtering apparatus according to claim 1.
